(19) United States
(12) Patent Application Publication
(10) Pub. No.: US 2024/0106046 A1
(43) Pub. Date: Mar. 28, 2024

(54) METHOD FOR CLADDING A BATTERY CELL

(71) Applicant: tesa SE, Norderstedt (DE)

(72) Inventors: Christian SCHUH, Norderstedt (DE); Sven HEIDSIECK, Norderstedt (DE); Alicia LEI GUI, Norderstedt (DE)

(73) Assignee: tesa SE, Norderstedt (DE)

(21) Appl. No.: 18/371,849

(22) Filed: Sep. 22, 2023

(30) Foreign Application Priority Data
Sep. 28, 2022 (DE) 102022124905.0

(51) Int. Cl. H01M 50/198; H01M 50/186; H01M 50/193; H01M 50/197

(52) U.S. Cl. CPC H01M 50/198; H01M 50/186; H01M 50/193; H01M 50/197; H01M 50/14

(57) ABSTRACT

Methods clad battery cells and comprise adhesively bonding at least one crosslinkable adhesive layer of a adhesive film and the at least one bottom side of a battery cell, adhesively bonding the at least one crosslinkable adhesive layer of the adhesive film and at least two first side walls of the battery cell, adhesively bonding the at least one crosslinkable adhesive layer of the adhessive film and at least two second side walls of the battery cell, and adhesively bonding the at least one crosslinkable adhesive layer of the adhesive film and at least one top side of the battery cell, wherein the methods further comprise at least partly crosslinking the crosslinkable adhesive layer.

This application claims foreign priority benefit under 35 U.S.C. § 119 of German Application No. 10 2022 124 905.0 filed Sep. 28, 2022.

The present invention relates to a method for cladding a battery cell. The present invention further relates to a clad battery cell obtained or obtainable according to this method.

For hybrid vehicles and all-electric vehicles, the stability and safety of the vehicle batteries are of critical importance. The reliability of the insulating part of the battery cells cladding is an important factor affecting the stability and safety of the battery cell.

The operating environment of a motor vehicle is acknowledged to be challenging, featuring high temperature, high humidity, severe vibrations, severe impacts, and so on. In such a rough environment, the stability and reliability of the insulating part of the battery cell are of great importance for preventing fracture and connection errors which may give rise to battery short-circuiting.

For the vehicle battery cell, one insulating method used at present involves wrapping a battery cell with a pressure-sensitive adhesive tape for insulation. Generally speaking, the adhesiveness of a pressure-sensitive adhesive tape is lower than 1 MPa, and the reliability of the pressure-sensitive adhesive tape is therefore insufficient if this insulating pressure-sensitive adhesive layer is part of an assembly produced using stronger adhesives.

It is therefore desirable to provide battery cell cladding methods which avoid or very largely avoid the disadvantages described for abovementioned methods. The methods of the present invention are intended in particular to increase the stability and reliability of the bonding of the adhesive film with which the battery cell is clad. Furthermore, the methods of the present invention enable reliable construction of battery assemblies. This means that multiple battery cells insulated with the insulating adhesive film may be connected structurally by the methods of the present invention with a bond strength of greater than 5 MPa.

This object is addressed by a method for cladding a battery cell and also by a battery cell obtained or obtainable by said method, having the features of the independent claims.

Advantageous developments which are realizable individually or in combination are set out in the description and the dependent claims.

The present invention therefore relates to a method for cladding a battery cell. The method comprises the steps identified in more detail below. These steps may be carried out in the stated order. More particularly, steps (i) to (iv) are carried out in this (chronological) order. In one variant of the method of the invention, the order of the component steps (v) and (vi) is changed round. In other words, the method is preferably carried out such that first steps (i) to (iv) take place, followed by steps (v) and (vi) or, conversely, by steps (vi) and (v).

The method of the invention therefore begins with step (i), then comes step (ii), then step (iii), then step (iv). Subsequently, step (v) and then step (vi) may take place, or, according to one alternative, first step (vi) and then step (v).

The at least one step of crosslinking may be carried out after the steps of (ii) to (vi). Furthermore, one or more of the stated method steps may be carried out once or else repeatedly. The method may comprise further method steps beyond the stated steps.

The present invention therefore relates to a method for cladding a battery cell, comprising
(i) providing a battery cell, where the battery cell comprises at least two opposite side walls S₁ and S₂, at least two opposite side walls S₃ and S₄, at least one bottom side U and at least one top side O;
(ii) providing an adhesive film, where the adhesive film comprises at least one crosslinkable adhesive layer and at least one carrier;
(iii) contacting the adhesive film of (ii) and the at least one bottom side U of the battery cell of (i), comprising adhesively bonding the at least one crosslinkable adhesive layer of the adhesive film and the at least one bottom side U of the battery cell;
(iv) contacting the adhesive film and the at least two side walls S₁ and S₂, comprising adhesively bonding the at least one crosslinkable adhesive layer of the adhesive film and the at least two side walls S₁ and S₂;
(v) contacting the adhesive film and the at least two side walls S₃ and S₄, comprising adhesively bonding the at least one crosslinkable adhesive layer of the adhesive film and the at least two side walls S₃ and S₄;
(vi) contacting the adhesive film and the at least one top side O, comprising adhesively bonding the at least one crosslinkable adhesive layer of the adhesive film and the at least one top side O of the battery cell;
   wherein the method further comprises at least one step of at least partly crosslinking the crosslinkable adhesive layer, where the at least one step of crosslinking may be carried out after the steps of (ii) to (vi).

The at least one step of crosslinking is preferably carried out after the step of (ii) or after the step of (vi).

With preference, the carrier comprises an insulating carrier, preferably an electrically insulating carrier, more preferably an electrically insulating carrier having a specific volume resistivity of >10¹⁵ Ωcm, preferably >10¹⁶ Ωcm, more preferably >10¹⁷ Ωcm, determined according to DIN EN 62631-3-1 (VDE 0307-3-1): 2017-01.

With preference, the carrier comprises one or more materials selected from the group consisting of polyimide, polybenzimidazole, polyamideimide, polyetherimide, polyacetal, polyphenylene sulfide, polyetheretherketone, polytetrafluoroethylene, polyamide 6, ultra-high molecular weight polyethylene, polypropylene, vinyl chloride resin, polystyrene, polyethylene terephthalate, acrylonitrile-butadiene-styrene, polycarbonate, polyvinyl chloride, ethylene-vinyl acetate and polyester, more preferably from the group consisting of polypropylene, polyethylene terephthalate, polycarbonate and polyvinyl chloride, more preferably from the group consisting of polypropylene and polyethylene terephthalate.

There are in principle no particular restrictions on the thickness of the carrier. The carrier preferably has a thickness in the range from 20 to 100 μm, more preferably in the 30 to 90 μm range, more preferably in the range from 40 to 75 μm.

There are in principle no particular restrictions on the thickness of the crosslinkable adhesive layer. The crosslinkable adhesive layer preferably has a thickness in the range from 10 to 150 μm, more preferably in the range from 10 to 100 μm, more preferably in the range from 20 to 60 μm.

The crosslinkable adhesive layer preferably comprises a crosslinkable pressure-sensitive adhesive. The crosslinkable pressure-sensitive adhesive preferably has a peel adhesion to steel of at least 1 N/cm in the non-crosslinked state, determined according to Test Method 2.

The crosslinkable pressure-sensitive adhesive is preferably crosslinkable by radiation with a wavelength in the range from 10 to 800 nm, more preferably by radiation with a wavelength in the range from 200 to 500 nm, more preferably by radiation with a wavelength in the range of 350 nm and 485 nm, more preferably by radiation from an LED light source having an emission maximum in the range from 350 nm to 485 nm.

The crosslinkable pressure-sensitive adhesive preferably comprises at least one polymer, at least one epoxy resin and at least one photoinitiator.

The crosslinkable pressure-sensitive adhesive preferably comprises:
(a) 25% to 75%, preferably 30% to 70%, by weight of at least one polymer;
(b) 20% to 70%, preferably 30% to 65%, by weight of at least one epoxy resin;
(c) 0.01% to 5%, preferably 1% to 4%, by weight of at least one cationic photoinitiator.

The at least one polymer preferably comprises one or more materials selected from the group consisting of polyacrylate, polyurethanes, poly(ethylene)-vinyl acetate copolymer, nitrile rubber and polyacrylate block copolymers, more preferably selected from the group consisting of polyacrylate, poly(ethylene)-vinyl acetate copolymer and polyacrylate block copolymers.

Polymers are understood to include those functionalized with functional groups, such as anhydride, acid, epoxide, hydroxyl, siloxane and oxazoline, for example.

The at least one epoxy resin preferably comprises at least one epoxy resin E₁ and at least one epoxy resin E₂.

The epoxy resin E₁ preferably comprises an epoxy resin E₁ which is solid or of high viscosity at 25° C., and the epoxy resin E₂ preferably comprises an epoxy resin E₂ which is liquid at 25° C.

In line with the understanding of the skilled person, epoxy resins are compounds which carry at least one oxirane group. They may be aromatic or aliphatic, more particularly cycloaliphatic in nature. Epoxy resins may comprise both monomeric and oligomeric or polymeric epoxy resins. Polymeric epoxy resins frequently have on average at least two epoxide groups per molecule, preferably more than two epoxide groups per molecule.

With preference the at least one epoxy resin E₁ and/or at least one epoxy resin E₂, preferably the at least one epoxy resin E₁ and at least one epoxy resin E₂, are selected from the group consisting of epoxide compounds having two or more epoxide groups, preferably two epoxide groups.

The oligomeric or polymeric epoxy resins usually comprise linear polymers having terminal epoxide groups (e.g. a diglycidyl ether of a polyoxyalkylene glycol), polymers having framework oxirane units (e.g. polybutadiene polyepoxide) and polymers having epoxide side groups (e.g. a glycidyl methacrylate polymer or copolymer). The molecular weight of such epoxy resins may vary from 58 to about 100,000 g/mol or more, the molecular weight being an important variable for the establishment of the dynamic viscosity. Illustrative polymerizable epoxy resins comprise epoxycyclohexanecarboxylates, such as for example 4-epoxycyclohexylmethyl 3,4-epoxycyclohexanecarboxylate, 3,4-epoxy-2-methylcyclohexylmethyl 3,4-epoxy-2-methylcyclohexanecarboxylate and bis(3,4-epoxy-6-methylcyclohexylmethyl) adipate. Further examples of polymerizable epoxy resins are disclosed for example in U.S. Pat. No. 3,117,099 A. Further polymerizable epoxy compounds particularly useful in the application of this invention comprise glycidyl ether monomers, as disclosed for example in U.S. Pat. No. 3,018,262. Examples are the glycidyl ethers of polyhydric phenols, obtained by reaction of a polyhydric phenol with an excess of chlorohydrin, such as epichlorohydrin (e.g. the diglycidyl ether of 2,2-bis(2,3-epoxypropoxyphenol)propane). More particularly, diglycidyl ethers of bisphenols, such as bisphenol A (4,4′-(propane-2,2-diyl)diphenol) and bisphenol F (bis(4-hydroxyphenyl)methane). Such reaction products are available commercially in different molecular weights and aggregate states (for example so-called type 1 to type 10 BADGE resins). Typical examples of liquid bisphenol A diglycidyl ethers are Epikote 828, D.E.R.331 and Epon 828. Typical solid BADGE resins are Araldite GT6071, GT7072, Epon 1001 and D.E.R. 662. Further reaction products of phenols with epichlorohydrin are the phenols and cresol novolac resins such as, for example, the Epiclon products or Araldite EPN and ECN products (e.g. ECN1273).

With preference the at least one epoxy resin E₁ and/or the at least one epoxy resin E₂, preferably the at least one epoxy resin E₁ and the at least one epoxy resin E₂, are selected from the group consisting of epoxide compounds having at least one cycloaliphatic group, preferably a cyclohexyl group or dicyclopentadienyl group. More preferably—additionally or alternatively—the at least one epoxy resin E₁ and/or the at least one epoxy resin E₂, preferably the at least one epoxy resin E₁ and the at least one epoxy resin E₂, are selected from the group consisting of bisphenol A diglycidyl ethers and bisphenol F diglycidyl ethers, preferably bisphenol A diglycidyl ethers.

The at least one epoxy resin E₁ preferably has a Tg of ≥25° C. and the at least one epoxy resin E₂ preferably has a Tg of <25° C., determined according to Test Method 3.

The at least one epoxy resin E₁ preferably has a dynamic viscosity at 25° C. of 100 Pa s or more, more preferably 150 Pa s or more, determined according to Test Method 4.

The at least one epoxy resin E₂ preferably has a dynamic viscosity at 25° C. of 30 Pa s or less, more preferably 20 Pa s or less, more preferably 10 Pa s or less, determined according to Test Method 4.

The epoxy resin E₁ is preferably selected from the group consisting of compounds which at 25° C. are solids or substances of high viscosity, the latter being defined for the purposes of the present invention via a lower dynamic viscosity limit at 25° C. The skilled person understands accordingly that the distinction between solids and corresponding substances of high viscosity is useful for practical application, as the viscosity of solids is intrinsically multiple powers of ten above the dynamic viscosity figure indicated above, but often in practice can hardly be sensibly determined, meaning that it is sufficient to state that it is a solid. Advantageously, because of the definition chosen, there is also no need to distinguish whether a substance at 25° C. is now a solid or is a substance of high viscosity having a corresponding dynamic viscosity. By contrast, the polymerizable epoxy resin E₂ for this purpose comprises liquids of low viscosity, which for the purposes of the present invention are defined via an upper dynamic viscosity limit at 25° C. For the purposes of the present invention, the dynamic viscosity is determined according to DIN 53019-1 from 2008, at 25° C., with a shear rate of 1 s⁻¹.

It is advantageous here if the chosen difference in the viscosities between epoxy resins E₁ and E₂ is relatively large. Preference is therefore given to at least one epoxy resin E₁ which at 25° C. has a dynamic viscosity of 100 Pa s or more, preferably of 150 Pa s or more. Further preference is given to at least one epoxy resin E₂ which at 25° C. has a dynamic viscosity of 30 Pa s or less, preferably 20 Pa s or less, very preferably 10 Pa s or less. With particular preference here, the corresponding preferred ranges are combined with one another.

The at least one epoxy resin E₁ preferably has a softening temperature of 45° C. or more, determined according to Test Method 5.

It is further preferred, accordingly, if the two above-described features of the epoxy resins are combined in that epoxy resins having at least one cycloaliphatic group are obtained by hydrogenation of corresponding bisphenol compounds. With particular preference, therefore, the at least one epoxy resin E₁ and/or the at least one epoxy resin E₂, preferably the at least one epoxy resin E₁ and the at least one epoxy resin E₂, are selected from the group consisting of hydrogenated bisphenol A diglycidyl ethers and hydrogenated bisphenol F diglycidyl ethers, preferably hydrogenated bisphenol A diglycidyl ethers. With further preference, the epoxy resin E₂ is selected from the group consisting of hydrogenated bisphenol A diglycidyl ethers and hydrogenated bisphenol F diglycidyl ethers, preferably hydrogenated bisphenol A diglycidyl ethers.

From the observations above it also follows that the use of solid epoxy resin E₁ is particularly preferred on account of the resulting large discrepancy in the dynamic viscosity. Further preferred, therefore, is at least one epoxy resin E₁ in the form of a solid having a softening temperature of 45° C. or more.

E₁:E₂ is preferably in the range from 10:1 to 1:10, more preferably in the range from 4:1 to 1:4.

The at least one photoinitiator preferably comprises one or more materials selected from the group consisting of sulfonium, iodonium and metallocene based systems.

For examples of sulfonium based cations, reference may be made to the observations in U.S. Pat. No. 6,908,722B1. Examples of anions which serve as counterions for the cations stated above include tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis(pentafluoromethylphenyl)borate, bi(trifluoromethylsulfonyl)amides and tris-(trifluoromethylsulfonyl)methides. Moreover, especially for iodonium-based initiators, conceivable anions also include chloride, bromide or iodide, although preferred initiators are those which are substantially free from chlorine and bromine. An effective example of such a system is, for example, triphenylsulfonium hexafluoroantimonate. Further suitable initiators are disclosed for example in U.S. Pat. Nos. 3,729,313 A, 3,741,769 A, 4,250,053 A, 4,394,403 A, 4,231,951 A, 4,256,828 A, 4,058,401 A, 4,138,255 A and US 2010/063221 A1.

Specific examples of sulfonium salts which can be used are triphenylsulfonium hexafluoroarsenate, triphenylsulfonium hexafluoroborate, triphenylsulfonium tetrafluoroborate, triphenylsulfonium tetrakis(pentafluorobenzyl)borate, methyldiphenylsulfonium tetrafluoroborate, methyldiphenylsulfonium tetrakis(pentafluorobenzyl)borate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritolylsulfonium hexafluorophosphate, anisyldiphenylsulfonium hexafluoroantimonate, 4-butoxyphenyldiphenylsulfonium tetrafluoroborate, 4-chlorophenyldiphenylsulfonium hexafluoroantimonate, tris(4-phenoxyphenyl)sulfonium hexafluorophosphate, di(4-ethoxyphenyl)methylsulfonium-hexafluoroarsenate, 4-acetylphenyldiphenylsulfonium tetrafluoroborate, 4-acetylphenyldiphenylsulfonium tetrakis(pentafluorobenzyl)borate, tris(4-thiomethoxyphenyl)sulfonium hexafluorophosphate, di(methoxysulfonylphenyl)methylsulfonium hexafluoroantimonate, di(methoxynaphthyl)methylsulfonium tetrafluoroborate, di(methoxynaphthyl)methylsulfonium tetrakis(penta-fluorobenzyl)borate, di(carbomethoxyphenyl)methylsulfonium hexafluorophosphate, (4-octyloxyphenyl)-diphenylsulfonium tetrakis(3,5-bis-trifluoromethylphenyl)borate, tris[4-(4-acetylphenyl)thiophenyl]-sulfonium tetrakis(pentafluorophenyl)borate, tris(dodecylphenyl)sulfonium tetrakis(3,5-bis-trifluoromethylphenyl)borate, 4-acetamidophenyldiphenylsulfonium tetrafluoroborate, 4-acetamidophenyldiphenylsulfonium tetrakis(pentafluorobenzyl)borate, dimethylnaphthylsulfonium hexafluorophosphate, trifluoromethyldiphenylsulfonium tetrafluoroborate, trifluoromethyldiphenylsulfonium tetrakis(pentafluorobenzyl)borate, phenylmethylbenzylsulfonium hexafluorophosphate, 5-methylthianthrenium hexafluorophosphate, 10-phenyl-9,9-dimethylthioxanthenium hexafluorophosphate, 10-phenyl-9-oxothioxanthenium tetrafluoroborate, 10-phenyl-9-oxothioxanthenium tetrakis(pentafluorobenzyl)borate, 5-methyl-10-oxothianthrenium tetrafluoroborate, 5-methyl-10-oxothianthrenium tetrakis(pentafluorobenzyl)-borate and 5-methyl-10,10-dioxothianthrenium hexafluorophosphate.

Specific examples of iodonium salts which can be used are diphenyliodonium tetrafluoroborate, di(4-methylphenyl)iodonium tetrafluoroborate, phenyl-4-methylphenyliodonium tetrafluoroborate, di(4-chlorophenyl)iodonium hexafluorophosphate, dinaphthyliodonium tetrafluoroborate, di(4-trifluoromethylphenyl)iodonium tetrafluoroborate, diphenyliodonium hexafluorophosphate, di(4-methylphenyl)iodonium hexafluorophosphate, diphenyliodonium hexafluoroarsenate, di-(4-phenoxyphenyl)iodonium tetrafluoroborate, phenyl-2-thienyliodonium hexafluorophosphate, 3,5-dimethylpyrazolyl-4-phenyliodonium hexafluorophosphate, diphenyliodonium hexafluoroantimonate, 2,2′-diphenyliodonium tetrafluoroborate, di-(2,4-dichlorophenyl)iodonium hexafluorophosphate, di(4-bromophenyl)iodonium hexafluorophosphate, di-(4-methoxyphenyl)iodonium hexafluorophosphate, di(3-carboxyphenyl)iodonium hexafluorophosphate, di-(3-methoxycarbonylphenyl)iodonium hexafluorophosphate, di(3-methoxysulfonylphenyl)iodonium hexafluorophosphate, di(4-acetamidophenyl)iodonium hexafluorophosphate, di(2-benzothienyl)iodonium hexafluorophosphate, diaryliodonium tristrifluoromethylsulfonylmethide such as diphenyliodonium hexafluoroantimonate, diaryliodonium tetrakis(pentafluorophenyl)borate such as diphenyliodonium tetrakis(pentafluorophenyl)borate, [4-(2-hydroxy-n-tetradesiloxy)phenyl]phenyliodonium hexafluoroantimonate, [4-(2-hydroxy-n-tetradesiloxy)phenyl]phenyliodonium trifluorosulfonate, [4-(2-hydroxy-n-tetradesiloxy)phenyl]phenyliodonium hexafluorophosphate, [4-(2-hydroxy-n-tetradesiloxy)-phenyl]phenyliodonium tetrakis(pentafluorophenyl)borate, bis(4-tert-butylphenyl)iodonium hexafluoroantimonate, bis(4-tert-butylphenyl)iodonium hexafluorophosphate, bis(4-tert-butylphenyl)iodonium trifluorosulfonate, bis(4-tert-butylphenyl)iodonium tetrafluoroborate, bis(dodecylphenyl)iodonium hexafluoroantimonate, bis(dodecylphenyl)iodonium tetrafluoroborate, bis(dodecylphenyl)iodonium hexafluorophosphate, bis(dodecylphenyl)iodonium trifluoromethylsulfonate, di(dodecylphenyl)iodonium hexafluoroantimonate, di(dodecylphenyl)iodonium triflate, diphenyliodonium bisulfate, 4,4′-dichlorodiphenyliodonium bisulfate, 4,4′-dibromodiphenyliodonium bisulfate, 3,3′-dinitrodiphenyliodonium bisulfate, 4,4′-dimethyldiphenyliodonium bisulfate, 4,4′-bis-succinimidodiphenyliodonium bisulfate, 3-nitrodiphenyliodonium bisulfate, 4,4′-dimethoxydiphenyliodonium bisulfate, bis(dodecylphenyl)iodonium tetrakis(pentafluorophenyl)borate, (4-octyloxyphenyl)phenyliodonium tetrakis-(3,5-bistrifluoromethylphenyl)borate and (tolylcumyl)iodonium tetrakis(pentafluorophenyl)borate, and ferrocenium salts (see for example EP 0 542 716 B1) such as η5-(2,4-cyclopentadien-1-yl)-[(1,2,3,4,5,6,9)-(1-methylethyl)-benzene]iron.

Photoinitiators are typically used individually or as a combination of two or more photoinitiators. When photoinitiators are used, combinations with so-called sensitizers for adapting the activation wavelength of the photoinitiation system to the chosen emission spectrum are very useful, and for the use reference may be made to the literature known to the skilled person, such as, for example, “Industrial Photoinitiators: A technical guide” 2010 by A. W. Green.

With preference, the crosslinkable pressure-sensitive adhesive additionally comprises
(d) 3% to 30%, more preferably 5% to 20%, more preferably 7% to 15%, by weight, based on the sum of the % by weight of the at least one polymer and of the at least one epoxy resin, of at least one elastomer-modified epoxide E₃.

The at least one elastomer-modified epoxide E₃ preferably comprises one or more materials selected from the group consisting of carboxy-terminated nitrile rubber, carboxy-terminated butadiene rubber, epoxy-terminated butadiene rubber, epoxy-terminated nitrile rubber, epoxy-functionalized polyurethane, polyester and polyether.

Elastomer-modified epoxide E₃ is understood in the sense of the present invention to refer to epoxides—especially liquid epoxides, generally of high viscosity—having a mean functionality of at least two and an elastomer content of up to 50% by weight, preferably such a content of 5% to 40% by weight. The epoxide groups may be located terminally and/or in the side chain of the molecule. The elastomeric structural component of these flexibilized epoxides consists of polyenes, diene copolymers and polyurethanes, preferably of polybutadiene, butadiene-styrene or butadiene-acrylonitrile copolymers.

An epoxy resin E₃ modified by butadiene-acrylonitrile copolymers (nitrile rubber) is, for example, an epoxide prepolymer which is obtained by modifying an epoxy resin having at least two epoxide groups in the molecules with a nitrile rubber. The epoxide basis used is advantageously a reaction product of glycerol or propylene glycol and a halogen-containing epoxide compound, such as epichlorohydrin, or the reaction product of a polyhydric phenol, such as hydroquinone, bisphenol A and a halogen-containing epoxide. A desirable reaction product is a reaction product of an epoxy resin of the bisphenol A type having two terminal epoxide groups.

To attach the epoxy resins E₃, it is possible in the case of butadiene polymers or butadiene-acrylonitrile copolymers (so-called nitrile rubbers) to copolymerize a third monomer with acid function—for example acrylic acid—to give so-called carboxy-terminated nitrile rubbers (CTBN). Generally speaking, these compounds contain acid groups not only at the ends but also along the main chain. CTBN are available, for example, under the trade name Hycar from B. F. Goodrich. They have molar masses of between 2000 and 5000 and acrylonitrile contents of between 10% and 30%. Specific examples are Hycar CTBN 1300 x 8, 1300 x 13 or 1300 x 15. The reaction with butadiene polymers proceeds correspondingly.

Reaction of epoxy resins with CTBN produces so-called epoxy-terminated nitrile rubbers (ETBN), which are used with particular preference for this invention. Commercially, such ETBN are available for example from Emerald Materials under the name HYPRO ETBN (formerly Hycar ETBN)—such as, for example, Hypro 1300X40 ETBN, Hypro 1300X63 ETBN and Hypro 1300X68 ETBN. One example of an epoxy-terminated butadiene rubber is Hypro 2000X174 ETB.

Further examples of elastomer-modified epoxy-terminated epoxides E₃ are a reaction product of a diglycidyl ether of neopentyl alcohol and a butadiene/acrylonitrile elastomer having carboxyl ends (e.g. EPON™ Resin 58034 from Resolution Performance Products LLC), a reaction product of a diglycidyl ether of bisphenol A and a butadiene/acrylonitrile elastomer having carboxyl ends (e.g. EPON™ Resin 58006 from Resolution Performance Products LLC), a butadiene/acrylonitrile elastomer having carboxyl ends (e.g. CTBN-1300X8 and CTBN-1300X13 from Noveon, Inc., Cleveland, Ohio) and a butadiene/acrylonitrile elastomer having amine ends (e.g. ATBN-1300X16 and ATBN-1300X42 from Noveon, Inc.). One example of the elastomer-modified epoxy resin adduct is the reaction product of an epoxy resin based on bisphenol F and a butadiene/acrylonitrile elastomer having carboxyl ends (e.g. EPON™ Resin 58003 from Resolution Performance Products LLC).

The at least two opposite side walls S₁ and S₂ preferably comprise at least two faces F₁ and F₂, with the side wall S₁ comprising the face F₁ and the side wall S₂ comprising the face F₂. The face F₁ and the face F₂ are preferably the same size.

The at least two opposite side walls S₃ and S₄ preferably comprise at least two faces F₃ and F₄, with the side wall S₃ comprising the face F₃ and the side wall S₄ comprising the face F₄.

The face F₃ and the face F₄ are preferably the same size. The faces F₁ and F₂ are preferably larger than the faces F₃ and F₄.

The battery cell is preferably rectangular.

The top side O preferably comprises battery contacts. According to one variant of the invention, the side walls S₃ and S₄ each have a battery contact.

The bottom side U is preferably opposite the top side O.

The at least partial crosslinking of the crosslinkable adhesive layer is preferably carried out after the step of (ii).

The at least partial crosslinking of the crosslinkable adhesive layer is preferably carried out after the step of (vi).

According to (ii), the adhesive film is preferably provided in the form of an adhesive film web wound to form a roll.

Preferably, (iii) comprises:
(iii.1) unwinding the adhesive film from the roll and simultaneously crosslinking the crosslinkable adhesive layer by radiation with a wavelength in the range from 10 to 800 nm, preferably is crosslinkable by radiation with a wavelength in the range from 200 to 500 nm, more preferably by radiation with a wavelength in the range of 350 nm and 485 nm, more preferably by radiation from an LED light source having an emission maximum in the range from 350 nm to 485 nm.

The adhesive film preferably has a width b and a length l.

In step (iii), the width b of the adhesive film preferably protrudes by area Δb₁ beyond the bottom side U of the battery cell.

In step (iv), the length l of the adhesive film preferably protrudes by area Δl₁ beyond the top side O of the battery cell.

In step (iv), the width b of the adhesive film preferably protrudes by area Δb₂ beyond the at least two opposite side walls S₁ and S₂ of the battery cell, where Δb₂<Δb₁.

In step (iv), the width b of the adhesive film preferably protrudes by area Δb₃ beyond the bottom side U of the battery cell, where Δb₃<Δb₂<Δb₁.

Preferably, (iv) comprises:
(iv.1) providing a bonding device comprising at least one pressing roller;
(iv.2) passing the at least one pressing roller over the side wall S₁ and/or the side wall S₂, comprising adhesively bonding the adhesive layer of the adhesive film and the side wall S₁ and/or the side wall S₂, preferably by pressing-on the adhesive layer of the adhesive film by means of the pressing roller.

Preferably, (v) comprises:
(v.1) applying Δb₃ to the at least two side walls S₃ and S₄, comprising adhesively bonding the adhesive layer of the adhesive film and the at least two side walls S₃ and S₄;
(v.2) applying Δb₂ to the at least two side walls S₃ and S₄, comprising adhesively bonding the adhesive layer of the adhesive film and the at least two side walls S₃ and S₄, to form area Δl₂, where Δl₂<Δl₁.

Preferably, (vi) comprises:
(vi.1) applying Δl₂ to the top side O of the battery cell, comprising adhesively bonding the adhesive layer of the adhesive film and the at least one top side O, to form area Δl₃, where Al₃<Δl₂;
(vi.2) applying Δl₃ to the top side O of the battery cell comprising adhesively bonding the adhesive layer of the adhesive film and the at least one top side O.

According to a further possible embodiment of the present invention, the method for cladding a battery cell comprises the steps of
(i) providing a battery cell, where the battery cell comprises at least two opposite side walls S₁ and S₂, at least two opposite side walls S₃ and S₄, at least one bottom side U and at least one top side O;
(ii) providing an adhesive film with a width b and a length l, where the adhesive film comprises at least one crosslinkable adhesive layer and at least one carrier;
(iii) contacting the adhesive film of (ii) and the at least one bottom side U of the battery cell of (i), comprising adhesively bonding the at least one crosslinkable adhesive layer of the adhesive film and the at least one bottom side U of the battery cell, where the width b of the adhesive film protrudes by Δb₁ beyond the bottom side U of the battery cell;
(iv) contacting the adhesive film and the at least two side walls S₁ and S₂, comprising adhesively bonding the at least one crosslinkable adhesive layer of the adhesive film and the at least two side walls S₁ and S₂, where the width b of the adhesive film protrudes by area Δb₂ beyond the at least two opposite side walls S₁ and S₂ of the battery cell, where Δb₂<Δb₁;
(v) contacting the adhesive film and the at least two side walls S₃ and S₄, comprising adhesively bonding the at least one crosslinkable adhesive layer of the adhesive film and the at least two side walls S₃ and S₄, where the width b of the adhesive film protrudes by area Δb₃ beyond the at least two opposite side walls S₃ and S₄ of the battery cell, where Δb₃<Δb₁;
(v.1) applying Δb₃ to the at least two side walls S₃ and S₄, comprising adhesively bonding the adhesive layer of the adhesive film and the at least two side walls S₃ and S₄;
(v.2) applying Δb₂ to the at least two side walls S₃ and S₄, comprising adhesively bonding the adhesive layer of the adhesive film and the at least two side walls S₃ and S₄, to form area Δl₂, where Δl₂<Δl₁;
(vi) contacting the adhesive film and the at least one top side O, comprising adhesively bonding the at least one crosslinkable adhesive layer of the adhesive film and the at least one top side O of the battery cell;
(vi.1) applying Δl₂ to the top side O of the battery cell, comprising adhesively bonding the adhesive layer of the adhesive film and the at least one top side O, to form area Δl₃, where Δl₃<Δl₂;
(vi.2) applying Δl₃ to the top side O of the battery cell, comprising adhesively bonding the adhesive layer of the adhesive film and the at least one top side O;
wherein the method further comprises at least one step of at least partly crosslinking the crosslinkable adhesive layer, where the at least one step of crosslinking is carried out after the step of (ii) or after the step of (vi).

The present invention further relates to a clad battery cell, obtainable or obtained by a method as described herein.

The present invention as described above is further described by the following set of embodiments and combinations of embodiments, with the combinations resulting from the corresponding dependencies and back-references. It should be pointed out in particular that in passages referring to a range of embodiments—as for example in connection with an expression such as “Method according to any of embodiments 1 to 5”—each individual embodiment within this range is disclosed as explicit for the skilled person, the skilled person thus understanding this expression to be synonymous with the expression “Method according to any of embodiments 1, 2, 3, 4 and 5”. It is further pointed out explicitly that the following set of embodiments represents not the set of claims determining the scope of protection, but rather a suitably structured part of the description that is directed to general and preferred aspects of the present invention.
1. Method for cladding a battery cell, comprising the steps of
   (i) providing a battery cell, where the battery cell comprises at least two opposite side walls S₁ and S₂, at least two opposite side walls S₃ and S₄, at least one bottom side U and at least one top side O;
   (ii) providing an adhesive film, where the adhesive film comprises at least one crosslinkable adhesive layer and at least one carrier;
   (iii) contacting the adhesive film of (ii) and the at least one bottom side U of the battery cell of (i), comprising adhesively bonding the at least one crosslinkable adhesive layer of the adhesive film and the at least one bottom side U of the battery cell;
   (iv) contacting the adhesive film and the at least two side walls S₁ and S₂, comprising adhesively bonding the at least one crosslinkable adhesive layer of the adhesive film and the at least two side walls S₁ and S₂;
   (v) contacting the adhesive film and the at least two side walls S₃ and S₄, comprising adhesively bonding the at least one crosslinkable adhesive layer of the adhesive film and the at least two side walls S₃ and S₄;
   (vi) contacting the adhesive film and the at least one top side O, comprising adhesively bonding the at least one crosslinkable adhesive layer of the adhesive film and the at least one top side O of the battery cell;
      wherein the method further comprises at least one step of at least partly crosslinking the crosslinkable adhesive layer, where the at least one step of crosslinking may be carried out after the steps of (ii) to (vi).
2. Method according to embodiment 1, wherein the carrier comprises an insulating carrier, preferably an electrically insulating carrier, more preferably an electrically insulating carrier having a specific volume resistivity of >10¹⁵ Ωcm, preferably >10¹⁶ Ωcm, more preferably >10¹⁷ Ωcm, determined according to DIN EN 62631-3-1 (VDE 0307-3-1): 2017-01.
3. Method according to embodiment 1 or 2, wherein the carrier comprises one or more materials selected from the group consisting of polyimide, polybenzimidazole, polyamideimide, polyetherimide, polyacetal, polyphenylene sulfide, polyetheretherketone, polytetrafluoroethylene, polyamide 6, ultra-high molecular weight polyethylene, polypropylene, vinyl chloride resin, polystyrene, polyethylene terephthalate, acrylonitrile-butadiene-styrene, polycarbonate, polyvinyl chloride, ethylene-vinyl acetate and polyester, preferably from the group consisting of polypropylene, polyethylene terephthalate, polycarbonate and polyvinyl chloride, more preferably from the group consisting of polypropylene and polyethylene terephthalate.
4. Method according to any of embodiments 1 to 3, wherein the carrier has a thickness in the range from 20 to 100 μm, preferably in the range from 30 to 90 μm, more preferably in the range from 40 to 75 μm.
5. Method according to any of embodiments 1 to 4, wherein the crosslinkable adhesive layer has a thickness in the range from 10 to 150 μm, preferably in the range from 10 to 100 μm, more preferably in the range from 20 to 60 μm.
6. Method according to any of embodiments 1 to 5, wherein the crosslinkable adhesive layer comprises a crosslinkable pressure-sensitive adhesive and wherein the crosslinkable pressure-sensitive adhesive has a peel adhesion to steel of at least 1 N/cm in the non-crosslinked state, determined according to Test Method 2.
7. Method according to embodiment 6, wherein the crosslinkable pressure-sensitive adhesive is crosslinkable by radiation with a wavelength in the range from 10 to 800 nm, more preferably by radiation with a wavelength in the range from 200 to 500 nm, more preferably by radiation with a wavelength in the range of 350 nm and 485 nm, more preferably by radiation from an LED light source having an emission maximum in the range from 350 nm to 485 nm.
8. Method according to embodiment 6 or 7, wherein the crosslinkable pressure-sensitive adhesive comprises at least one polymer, at least one epoxy resin and at least one photoinitiator.
9. Method according to any of embodiments 6 to 8, wherein the crosslinkable pressure-sensitive adhesive comprises
   (a) 25% to 75%, preferably 30% to 70%, by weight of at least one polymer;
   (b) 20% to 70%, preferably 30% to 65%, by weight of at least one epoxy resin;
   (c) 0.01% to 5%, preferably 1% to 4%, by weight of at least one cationic photoinitiator.
10. Method according to embodiment 8 or 9, wherein the at least one polymer comprises one or more materials selected from the group consisting of polyacrylate, polyurethane, poly(ethylene)-vinyl acetate copolymer, nitrile rubber and polyacrylate block copolymers, preferably selected from the group consisting of polyacrylate, poly(ethylene)-vinyl acetate copolymer and polyacrylate block copolymers.
11. Method according to any of embodiments 8 to 10, wherein the at least one epoxy resin comprises at least one epoxy resin E₁ and at least one epoxy resin E₂.
12. Method according to embodiment 11, wherein the epoxy resin E₁ comprises an epoxy resin E₁ which is solid or of high viscosity at 25° C. and the epoxy resin E₂ comprises an epoxy resin E₂ which is liquid at 25° C.
13. Method according to embodiment 11 or 12, wherein the at least one epoxy resin E₁ has a Tg of ≥25° C. and the at least one epoxy resin E₂ has a Tg of <25° C., determined according to Test Method 3.
14. Method according to any of embodiments 11 to 13, wherein the at least one epoxy resin E₁ has a dynamic viscosity at 25° C. of 100 Pa s or more, preferably of 150 Pa s or more, determined according to Test Method 4.
15. Method according to any of embodiments 11 to 14, wherein the at least one epoxy resin E₂ has a dynamic viscosity at 25° C. of 30 Pa s or less, preferably 20 Pa s or less, more preferably 10 Pa s or less, determined according to Test Method 4.
16. Method according to any of embodiments 11 to 15, wherein the at least one epoxy resin E₁ has a softening temperature of 45° C. or more, determined according to Test Method 5.
17. Method according to any of embodiments 11 to 16, wherein E₁:E₂ is in the range from 10:1 to 1:10, preferably in the range from 4:1 to 1:4.
18. Method according to any of embodiments 8 to 17, wherein the at least one photoinitiator comprises one or more materials selected from the group consisting of sulfonium, iodonium and metallocene based systems.
19. Method according to any of embodiments 6 to 18, wherein the crosslinkable pressure-sensitive adhesive additionally comprises
   (d) 3% to 30%, preferably 5% to 20%, more preferably 7% to 15%, by weight, based on the sum of the % by weight of the at least one polymer and of the at least one epoxy resin, of at least one elastomer-modified epoxide E₃.
20. Method according to embodiment 19, wherein the at least one elastomer-modified epoxide E₃ comprises one or more materials selected from the group consisting of carboxy-terminated nitrile rubber, carboxy-terminated butadiene rubber, epoxy-terminated butadiene rubber, epoxy-terminated nitrile rubber, epoxy-functionalized polyurethane, polyester and polyether.
21. Method according to any of embodiments 1 to 20, wherein the at least two opposite side walls S₁ and S₂ comprise at least two faces F₁ and F₂, where the side wall S₁ comprises the face F₁ and the side wall S₂ comprises the face F₂.
22. Method according to embodiment 21, wherein the face F₁ and the face F₂ are the same size.
23. Method according to any of embodiments 1 to 22, wherein the at least two opposite side walls S₃ and S₄ comprise at least two faces F₃ and F₄, where the side wall S₃ comprises the face F₃ and the side wall S₄ comprises the face F_{4.}
24. Method according to embodiment 23, wherein the face F₃ and the face F₄ are the same size.
25. Method according to any of embodiments 21 to 24, wherein the faces F₁ and F₂ are larger than the faces F₃ and F₄.
25. Method according to any of embodiments 1 to 24, wherein the battery cell is rectangular.
26. Method according to any of embodiments 1 to 25, wherein the top side O comprises battery contacts or the side wall S₃ and the side wall S₄ each comprise a battery contact.
27. Method according to any of embodiments 1 to 26, wherein the bottom side U is opposite the top side O.
29. Method according to any of embodiments 1 to 27, wherein the at least partial crosslinking of the crosslinkable adhesive layer is carried out after the step of (ii).
31. Method according to any of embodiments 1 to 27, wherein the at least partial crosslinking of the crosslinkable adhesive layer is carried out after the step of (vi).
32. Method according to any of embodiments 1 to 31, wherein the adhesive film in (ii) is provided in the form of an adhesive film web wound to form a roll.
33. Method according to any of embodiments 1 to 32, preferably embodiment 32, wherein (iii) comprises:
   (iii.1) unwinding the adhesive film from the roll and simultaneously crosslinking the crosslinkable adhesive layer by radiation with a wavelength in the range from 10 to 800 nm, preferably is crosslinkable by radiation with a wavelength in the range from 200 to 500 nm, more preferably by radiation with a wavelength in the range of 350 nm and 485 nm, more preferably by radiation from an LED light source having an emission maximum in the range from 350 nm to 485 nm.
34. Method according to any of embodiments 1 to 33, wherein the adhesive film has a width b and a length l.
35. Method according to embodiment 34, wherein in step (iii) the width b of the adhesive film protrudes by area Δb₁ beyond the bottom side U of the battery cell.
36. Method according to embodiment 34 or 35, wherein in step (iv) the length l of the adhesive film protrudes by area Δl₁ beyond the top side O of the battery cell.
37. Method according to any of embodiments 34 to 36, wherein in step (iv) the width b of the adhesive film protrudes by area Δb₂ beyond the at least two opposite side walls S₁ and S₂ of the battery cell, where Δb₂<Δb₁.
38. Method according to any of embodiments 34 to 37, wherein in step (iv) the width b of the adhesive film protrudes by area Δb₃ beyond the bottom side U of the battery cell, where Δb₃<Δb₂<Δb₁.
39. Method according to any of embodiments 1 to 38, wherein (iv) comprises:
   (iv.1) providing a bonding device comprising at least one pressing roller;
   (iv.2) passing the at least one pressing roller over the side wall S₁ and/or the side wall S₂, comprising adhesively bonding the adhesive layer of the adhesive film and the side wall S₁ and/or the side wall S₂, preferably by pressing-on the adhesive layer of the adhesive film by means of the pressing roller.
40. Method according to any of embodiments 34 to 39, wherein (v) comprises:
   (v.1) applying Δb₃ to the at least two side walls S₃ and S₄, comprising adhesively bonding the adhesive layer of the adhesive film and the at least two side walls S₃ and S₄;
   (v.2) applying Δb₂ to the at least two side walls S₃ and S₄, comprising adhesively bonding the adhesive layer of the adhesive film and the at least two side walls S₃ and S₄, to form area Δl₂, where Δl₂<Δl₁.
41. Method according to any of embodiments 34 to 40, wherein (vi) comprises:
   (vi.1) applying Δl₂ to the top side O of the battery cell, comprising adhesively bonding the adhesive layer of the adhesive film and the at least one top side O, to form area Δl₃, where Δl₃<Δl₂;
   (vi.2) applying Δl₃ to the top side O of the battery cell, comprising adhesively bonding the adhesive layer of the adhesive film and the at least one top side O.
42. Method for cladding a battery cell, comprising the steps of
   (i) providing a battery cell, where the battery cell comprises at least two opposite side walls S₁ and S₂, at least two opposite side walls S₃ and S₄, at least one bottom side U and at least one top side O;
   (ii) providing an adhesive film with a width b and a length l, where the adhesive film comprises at least one crosslinkable adhesive layer and at least one carrier;
   (iii) contacting the adhesive film of (ii) and the at least one bottom side U of the battery cell of (i), comprising adhesively bonding the at least one crosslinkable adhesive layer of the adhesive film and the at least one bottom side U of the battery cell, where the width b of the adhesive film protrudes by area Δb₁ beyond the bottom side U of the battery cell where Δb₁<b;
   (iv) contacting the adhesive film and the at least two side walls S₁ and S₂, comprising adhesively bonding the at least one crosslinkable adhesive layer of the adhesive film and the at least two side walls S₁ and S₂, where the width b of the adhesive film protrudes by area Δb₂ beyond the at least two opposite side walls S₁ and S₂ of the battery cell, where Δb₂<Δb₁;
   (v) contacting the adhesive film and the at least two side walls S₃ and S₄, comprising adhesively bonding the at least one crosslinkable adhesive layer of the adhesive film and the at least two side walls S₃ and S₄, where the width b of the adhesive film protrudes by area Δb₃ beyond the at least two opposite side walls S₃ and S₄ of the battery cell, where Δb₃<Δb₁;
      (v.1) applying Δb₂ to the at least two side walls S₃ and S₄, comprising adhesively bonding the adhesive layer of the adhesive film and the at least two side walls S₃ and S₄;
      (v.2) applying Δb₂ to the at least two side walls S₃ and S₄, comprising adhesively bonding the adhesive layer of the adhesive film and the at least two side walls S₃ and S₄, to form area Δl₂, where Δl₂<Δl₁;
   (vi) contacting the adhesive film and the at least one top side O, comprising adhesively bonding the at least one crosslinkable adhesive layer of the adhesive film and the at least one top side O of the battery cell;
      (vi.1) applying Δl₂ to the top side O of the battery cell, comprising adhesively bonding the adhesive layer of the adhesive film and the at least one top side O, to form area Δl₃, where Δl₃<Δl₂;
      (vi.2) applying Δl₃ to the top side O of the battery cell, comprising adhesively bonding the adhesive layer of the adhesive film and the at least one top side O;
   wherein the method further comprises at least one step of at least partly crosslinking the crosslinkable adhesive layer, where the at least one step of crosslinking is carried out after the step of (ii) or after the step of (vi).
43. Clad battery cell, obtainable or obtained by a method according to any of embodiments 1 to 42.

### DESCRIPTION OF THE FIGURES

Further details and features of the present invention are apparent from the description of figures and exemplary embodiments. In this context, the respective features may be actualized on their own or multiply in combination with one another. The invention is not confined to the exemplary embodiments. The exemplary embodiments are represented schematically in the figures. Identical reference numbers in the individual figures here designate identical or functionally identical elements or elements that correspond to one another in terms of their functions. The figures are described jointly.

FIG. 1a shows a battery cell in an embodiment of the present disclosure and FIG. 1b shows a method for cladding a battery cell in an embodiment of the present disclosure.

FIGS. 2-7 show methods for cladding a battery cell in embodiments of the present disclosure.

### DETAILED DESCRIPTION OF THE DISCLOSURE

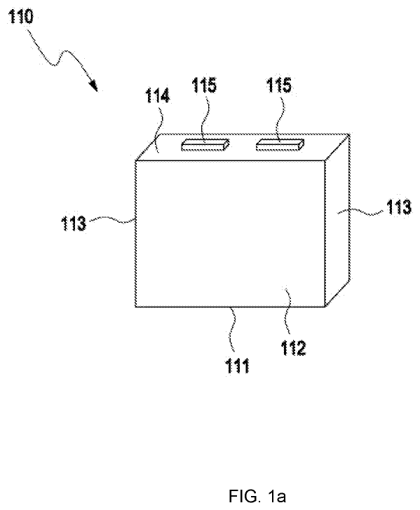

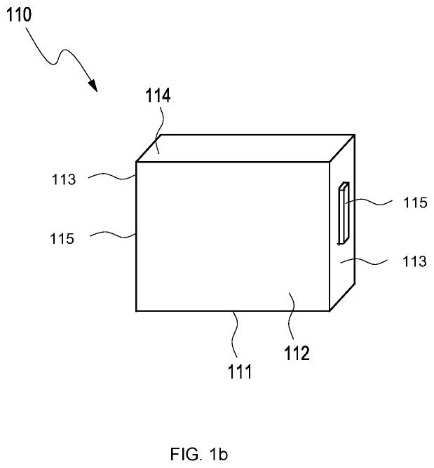

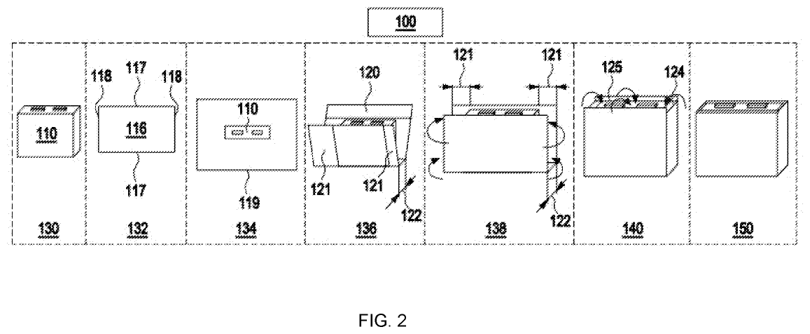

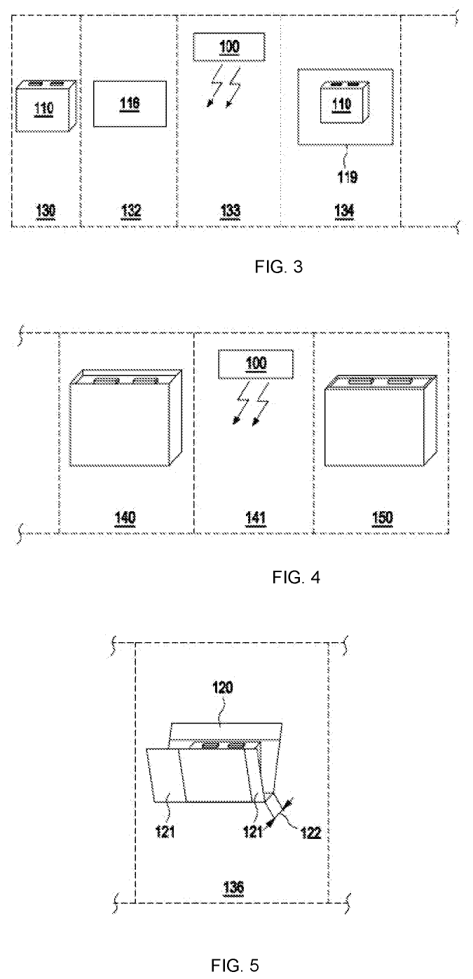

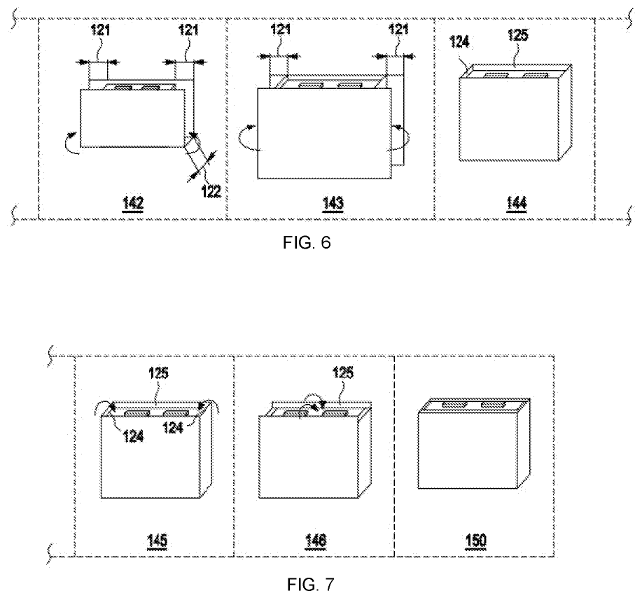

FIG. 1a shows a battery cell 110 comprising a bottom side U 111, two opposite side walls S₁ and S₂ 112, two opposite side walls S₃ and S₄ 113, the top side O 114 and two battery contacts 115 on the top side 114. FIG. 1b shows a different variant of a battery cell 110 comprising a bottom side U 111, two opposite side walls S₁ and S₂ 112, two opposite side walls S₃ and S₄ 113, each bearing a battery contact 115, and a top side O 114. FIGS. 2-7 show various exemplary embodiments of a method for cladding a battery cell 110 according to FIG. 1a. In particular, FIG. 2 shows an exemplary embodiment of a method for cladding a battery cell 110. Step (i) 130 shows the provision of a battery cell 110, the battery cell comprising at least two opposite side walls S₁ and S₂, at least two opposite side walls S₃ and S₄, at least one bottom side U and at least one top side O. Step (ii) 132 shows the provision of an adhesive film 116 having a width b 118 and a length l 117. Step (iii) 134 shows the contacting of the adhesive film 116 and the at least one bottom side U of the battery cell 110, comprising adhesively bonding the at least one crosslinkable adhesive layer of the adhesive film 116 and the at least one bottom side U 111 of the battery cell, where the width b 118 of the adhesive film 116 protrudes by area Δb₁ 119 beyond the bottom side U 111 of the battery cell 110. Step (iv) 136 shows the contacting of the adhesive film 116 and the at least two side walls S₁ and S₂ 112, comprising adhesively bonding the at least one crosslinkable adhesive layer of the adhesive film 116 and the at least two side walls S₁ and S₂ 112, where the width b 118 of the adhesive film protrudes by area Δb₂ 121 beyond the at least two opposite side walls S₁ and S₂ 112 of the battery cell 110 and where the length l 117 protrudes by area Δl₁ 120 beyond the top side O 114 of the battery cell 110. Steps (v) 138 and (vi) 140 show the contacting of the adhesive film 116 and the at least two side walls S₃ and S₄ 113, comprising adhesively bonding the at least one crosslinkable adhesive layer of the adhesive film 116 and the at least two side walls S₃ and S₄ 113, where the width b 118 of the adhesive film 116 protrudes by area Δb₃ 122 beyond the bottom side of the battery cell 110, where Δb₃ 122 is adhered to the at least two side walls S₃ and S₄ 113 and where Δb₂ 121 is adhered to the at least two side walls S₃ and S₄ 113, comprising adhesively bonding the adhesive layer of the adhesive film 116 and the at least two side walls S₃ and S₄ 113, to form area Δl₂ 124. Step (vi) 140 shows the contacting of the adhesive film 116 and the at least one top side O 114, comprising adhesively bonding the at least one crosslinkable adhesive layer of the adhesive film 116 and the at least one top side O 114 of the battery cell 110, where Δl₂ 124 is adhered to the top side O 114 of the battery cell 110 to form area Δl₃ 125 and where Δl₃ 125 is adhered to the top side O 114 of the battery cell 110, comprising adhesively bonding the adhesive layer of the adhesive film 116 and the at least one top side O 114. Moreover FIG. 2 shows an exemplary embodiment of a clad battery cell 150 and an exemplary embodiment of a method for cladding a battery cell 110, which further comprises at least one step of at least partly crosslinking the crosslinkable adhesive layer with a crosslinking unit 100. FIG. 3 shows an exemplary embodiment of a method for cladding a battery cell 110, where the at least partial crosslinking of the crosslinkable adhesive layer is carried out after the step of (ii) with a crosslinking unit 100 in step 133. FIG. 4 shows an exemplary embodiment of a method for cladding a battery cell 110, where the at least partial crosslinking of the crosslinkable adhesive layer is carried out after the step of (vi) with a crosslinking unit 100 in step 141. FIG. 5 shows an enlarged detail from step (iv) 136. FIG. 6 shows a preferred exemplary embodiment of steps (v) 138 and (vi) 140, where in step 142 first Δb₃ 122 is adhered to the at least two side walls S₃ and S₄ 113. Thereafter, in step 143, Δb₂ 121 is adhered to the at least two side walls S₃ and S₄ 113, to form area Δl₂ 124. FIG. 7 shows a preferred exemplary embodiment of step 140, wherein the contacting of the adhesive film 116 and the at least one top side O 114, comprising adhesively bonding the at least one crosslinkable adhesive layer of the adhesive film 116 and the at least one top side O 114 of the battery cell 110. In this case, in step 145, first Δl₂ 124 is adhered to the top side O 114 of the battery cell 110 to form area Δl₃ 125. Thereafter, Δl₃ 125 is adhered to the top side O 114 of the battery cell 110.

The method for cladding a battery cell 110, as shown in FIG. 1b, proceeds analogously. The method begins with the provision of a battery cell 110, where the battery cell comprises at least two opposite side walls S₁ and S₂, at least two opposite side walls S₃ and S₄, at least one bottom side U and at least one top side O. A battery contact is present on each of the two opposite side walls S₃ and S₄.

The adhesive film comprising at least one crosslinkable adhesive layer and at least one carrier dads the two opposite side walls S₁ and S₂, the bottom side U and the top side O in one piece, with the ends of the adhesive film being adhered overlappingly to one another. The adhesive film has a larger width than the opposite side walls S₁ and S₂, the bottom side U and the top side O, and so the adhesive film exhibits a protrusion at the two opposite side walls S₃ and S₄, which each have a battery contact. The individual portions forming the protrusion at the side walls S₁ and S₂, at the bottom side U and at the top side O are folded over in any order and stuck on the respective side wall S₃ and S₄.

The method for cladding a battery cell 110 that is shown in FIGS. 2-7 and described in the disclosure associated with the figures, where there are two battery contacts on the top side O, can be transposed analogously to a battery cell 110 in which the side walls S₃ and S₄ each have a battery contact. In this variant of the method of the invention, the order of the component steps (v) and (vi) is switched.

### LIST OF REFERENCE SYMBOLS

100 crosslinking unit
110 battery cell
111 bottom side
112 side walls S₁ and S₂
113 side walls S₃ and S₄
114 top side O
115 battery contacts
116 adhesive film
117 length l
118 width b
119 area Δb₁
120 area Δl₁
121 area Δb₂
122 area Δb₃
124 area Δl₂
125 area Δl₃
130 step (i)
132 step (ii)
133 crosslinking of the crosslinkable adhesive layer after the step of (ii)
134 step (iii)
136 step (iv)
138 step (v)
140 step (vi)
141 crosslinking of the crosslinkable adhesive layer after the step of (vi)
142 step (v.1)
143 step (v.2)
144 partially clad battery cell
145 step (vi.1)
146 step (vi.2)
150 clad battery cell

### DESCRIPTION OF EXEMPLARY EMBODIMENTS

### Test Methods

### Test Method 1: Specific Volume Resistivity

The specific volume resistivity was determined according to DIN EN 62631-3-1 (VDE 0307-3-1): 2017-01.

### Test Method 2: Peel Adhesion

The peel adhesions were determined in analogy to ISO 29862 (Method 3) at 23° C. and 50% relative humidity with a removal velocity of 300 mm/min and a removal angle of 180°. The substrates used were steel plates in accordance with the standard. The measurement strip was bonded using a roller application machine at 4 kg at a temperature of 23° C. The adhesive films were removed immediately after application or after a storage time of 24 h. The measurement value (in N/cm) was obtained as the mean value from three individual measurements.

### Test Method 3: Tg

The glass transition temperature of polymers is determined by means of dynamic scanning calorimetry (DSC). For this determination, around 5 mg of the untreated polymer samples are weighed into a small aluminium crucible (volume 25 μl) and closed with a perforated lid. Measurement takes place using a DSC 204 F1 from Netzsch, operating under nitrogen for inertness. The sample is first cooled to −150° C., heated to +150° C. at a heating rate of 10 K/min, and cooled again to −150° C. The subsequent, second heating curve is run again at 10 K/min and the change in the heat capacity is recorded. Glass transitions are recognized as steps in the thermogram. The glass transition temperature is evaluated as follows: a tangent is applied in each case to the baseline of the thermogram before 1 and after 2 of the step. In the region of the step, a line of best fit 3 is placed parallel to the ordinate in such a way as to intersect the two tangents, specifically so as to form two areas 4 and 5 (between the respective tangent, the line of best fit, and the measurement plot), of equal area. The point of intersection of the line of best fit positioned accordingly and the measurement plot gives the glass transition temperature.

### Test Method 4: Dynamic Viscosity

For the purposes of the present invention, the dynamic viscosity is measured according to DIN 53019-1: from 2008-09; at 25° C., with a shear rate of 1 s⁻¹.

### Test Method 5: Softening Temperature

For the purposes of the present invention, the softening temperature is carried out in accordance with the relevant methodology, which is known as ring & ball and is standardized according to ASTM E28 (1.7.2018).

The determination of the softening temperature of the resin uses an HRB 754 automated ring & ball tester from Herzog. Resin specimens are first finely mortared. The resulting powder is introduced into a brass cylinder with a base aperture (internal diameter at the top part of the cylinder 20 mm, diameter of the base aperture in the cylinder 16 mm, cylinder height 6 mm) and melted on a hotplate. The amount introduced is chosen such that the resin, after melting, fully fills the cylinder without protruding.

The resulting sample body, complete with cylinder, is inserted into the sample mount of the HRB 754. Glycerol is used to fill the heating bath if the softening temperature lies between 50° C. and 150° C. If softening temperatures are lower a water bath may also be employed. The test balls have a diameter of 9.5 mm and weigh 3.5 g. In line with the HRB 754 procedure, the ball is arranged above the sample body in the heating bath and is placed down on the sample body. Located 25 mm below the base of the cylinder is a catch plate, with a light barrier 2 mm above it. During the measuring procedure, the temperature is raised at 5° C./min. Within the temperature range of the softening temperature, the ball begins to move through the base aperture in the cylinder until eventually it comes to rest on the catch plate. In this position, it is detected by the light barrier, and the temperature of the heating bath at this point in time is registered. A duplicate determination takes place. The softening temperature is the average value from the two individual measurements.

The raw materials used in the inventive and comparative examples are summarized in Table 1.

TABLE 1
Raw materials used

| | |
|---|---|
| Polyacrylate | BA-GMA copolymer with a reactive fraction of 10 wt % |
| | GMA |
| Levamelt | Ethylene-vinyl acetate copolymer from Arlanxeo with |
| 700 | 70% vinyl acetate fraction |
| Breon | Hot-polymerized nitrile rubber with 42% acrylonitrile |
| N45H80 | fraction |
| Araldite | Liquid bisphenol A epoxy resin from Huntsman with an |
| GY-250 | epoxide equivalent of 183-189 g/eq |
| Araldite | Solid bisphenol A epoxy resin from Huntsman with an |
| GT-6071 | epoxide equivalent of 450-465 g/eq |
| Voranol | Polyether polyol with a molecular weight of M = 700 |
| 2070 | g/mol |
| KH-560 | 3-Glycidyloxypropyltrimethoxysilane |
| Dyhard | Dicyandiamide from Alzchem with a particle size of less |
| 100S | than 10 μm |
| Curezol | 2,4-Diamino-6-[2′-methylimidazol-1′-yl]-ethyl-s-triazine |
| 2MZ-A | from Evonik |
| Photoinitiator | Triarylsulfonium hexafluoroantimonate salts |
| PET-Träger | 50 μm transparent PET film from Fatra |

### Inventive Examples K1-K3 and Comparative Examples V1-V3

The adhesive layer of Inventive Examples K1-K3 and of Comparative Examples V2-V3 were produced according to the weight ratios in % by weight in Table 2. Comparative Example V1 is a commercially available, electrically insulating adhesive tape, tesa®58353, consisting of 50 μm polyethylene terephthalate carrier with 35 μm acrylate adhesive layer.

TABLE 2
Inventive Examples K1-K3 and Comparative Examples V1-V3

| | K1 | K2 | K3 | V1 | V2 | V3 |
|---|---|---|---|---|---|---|
| Polyacrylate | 50 | | | | | |
| Breon | | | 40 | | | |
| N45H80 | | | | | | |
| Levamelt 700 | | 40 | | | 40 | 20 |
| Araldite | 40 | 30 | 30 | | 60 | 40 |
| GY250 | | | | | | |
| Araldite | 10 | 20 | 30 | | | 40 |
| GT6071 | | | | | | |
| Voranol 2070 | 1 | 10 | | | | |
| KH-560 | 1 | | | | | |
| Photoinitiator | 1 | 1 | | | 1 | 1 |
| Dyhard 100S | | | 2.96 | | | |
| Curezol 2MZ- | | | 1.2 | | | |
| A | | | | | | |
| Bond | >4 MPa | >4 MPa | >4 MPa | <1 MPa | >4 MPa | >4 MPa |
| strength | | | | | | |
| (steel-steel) | | | | | | |
| Peel | >1 N/cm | >1 N/cm | >1 N/cm | >1 N/cm | cohesive | cohesive |
| adhesion | adhesive | adhesive | adhesive | adhesive | failure, | failure, |
| | failure | failure | failure | failure | no PSA* | no PSA* |

* PSA = pressure-sensitive adhesive
The adhesives in solution in butanone were coated out in a layer thickness of 35 μm onto a 50 μm polyethylene terephthalate carrier, freed from the solvent in a drying oven at 105° C. and enveloped with a siliconized PET liner.

### Bond Strength

The bond strength of the adhesive layer obtained was measured in 100 μm layer thickness and reported in MPa.

Curing conditions: Inventive Examples K1 and K2 and Comparative Examples V2 and V3 were irradiated using 365 nm UV-LED irradiation at 4 J/cm² and bonded within less than a minute after activation. Measurement took place after an after-cure time of 7 days at 23° C. Comparative Example V1 is a non-reactive pressure-sensitive adhesive, thus requiring no activation. Inventive Example K3 is a thermally curable reactive pressure-sensitive adhesive which following application is cured at 145° C. for 25 minutes.

Determination of bond strength via tensile lap-shear test:

As a parameter of the quality of the bonding achieved, the bond strength of an assembly produced by the method of the invention was ascertained for the various adhesive tapes. This was done by quantitative determination of the bond strength in each case in a dynamic tensile lap-shear test in accordance with DIN EN 1465: 2009-07 at 23° C. and 50% rh with a testing velocity of 10 mm/min (results in N/mm²=MPa). Test bars employed were steel bars cleaned with acetone prior to bonding. The figure reported is the mean from three measurements.

### METHOD EXAMPLES

Suitability for bubble-free bonding of the adhesive film to the battery cell walls is possessed for example by rollers which press the adhesive tape onto the battery cell wall with a rolling action beginning from one side.

### Method Example M1

A rectangular piece of a PET adhesive film with a crosslinkable adhesive layer was cut to shape and freed from the liner. The adhesive film was then irradiated with a dose of 4 J/cm² using a Hoenle UV-LED 365 nm (UV-LED, 365 nm, 4 s at 1000 mJ/cm² s). The adhesive layer used was K2. The cladding of the battery cell was carried out in the following order:
1) bonding of the adhesive layer of the adhesive film with the bottom side U of the battery cell;
2) bonding of the adhesive layer of the adhesive film with the two large side walls S₁ and S₂;
3) bonding of the protrusion Δb₃ on the bottom side U to the small side walls S₃ and S₄;
4) bonding of the lateral protrusion Δb₂ to the small side walls S₃ and S₄;
5) bonding of the protrusion Al₂ of the small side walls S₃ and S₄ to the top side O of the battery cell;
6) bonding of the protrusion Δl₃ of the large side walls S₁ and S₂ to the top side O of the battery cell.

### Method Example M2

Method Example M2 was carried out like Method Example M1, with the irradiation being carried out with the liner. Irradiation took place with a dose of 4 J/cm² (UV-LED 365 nm, 4 s at 1000 mJ/cm² s) and thereafter the liner was removed and the battery cell was clad as described in Method Example M1.

### Method Example M3

Method Example M3 was carried out like Method Example M1, with the difference that the adhesive film was irradiated only after the complete cladding of the battery cell. In this case, a dose of greater than 5 J/cm² (UV-LED 365 nm, 10 s at 1000 mJ/cm² s on each side) was used in order to reach the regions in which the adhesive film has multiple plies, owing to folding operations and oversticking.

### Method Example M4

A rectangular piece of a PET adhesive film with a crosslinkable adhesive layer was cut to shape and freed from the liner. The adhesive layer used was K3. The cladding of the battery cell was carried out in the following order:
1) bonding of the adhesive layer of the adhesive film with the bottom side U of the battery cell;
2) bonding of the adhesive layer of the adhesive film with the two large side walls S₁ and S₂;
3) bonding of the protrusion Δb₃ on the bottom side U to the small side walls S₃ and S₄;
4) bonding of the lateral protrusion Δb₂ to the small side walls S₃ and S₄;
5) bonding of the protrusion Δl₂ of the small side walls S₃ and S₄ to the top side O of the battery cell;
6) bonding of the protrusion Δl₃ of the large side walls S₁ and S₂ to the top side O of the battery cell.

Following the cladding of the battery cell, the adhesive film was exposed to thermal energy (20 minutes at 140° C.).

### Method Example M5

Method Example M5 was carried out like Method Example M1, using adhesive layer K1.

### COMPARATIVE METHOD EXAMPLES

### Comparative Method Example CM1

A rectangular piece of a PET adhesive film with a crosslinkable adhesive layer was cut to shape and freed from the liner. The adhesive film was then irradiated with a dose of 4 J/cm² using a Hoenle UV-LED 365 nm. The adhesive layer used was K2. The cladding of the battery cell was carried out in the following order:
1) bonding of the adhesive layer of the adhesive film with the bottom side U of the battery 25 cell;
2) bonding of the adhesive layer of the adhesive film with the two large side walls S₁ and S₂;
3) bonding of the lateral protrusion Δb₂ to the small side walls S₃ and S₄;
4) bonding of the protrusion Δb₃ on the bottom side U to the small side walls S₃ and S₄;
5) bonding of the protrusion Δl₂ of the small side walls to the top side O of the battery cell;
6) bonding of the protrusion Δl₃ of the large side walls to the top side O of the battery cell.

In CM1, in comparison to M1 -M5, the order of steps 3) and 4) is reversed.

### Comparative Method Example CM2

A rectangular piece of a PET adhesive film with a crosslinkable adhesive layer was cut to shape and freed from the liner. The adhesive film was then irradiated with a dose of 4 J/cm² using a Hoenle UV-LED 365 nm. The adhesive layer used was K2. The cladding of the battery cell was carried out in the following order:
1) bonding of the adhesive layer of the adhesive film with the bottom side U of the battery cell;
2) bonding of the adhesive layer of the adhesive film with the two large side walls S₁ and S₂;
3) bonding of the lateral protrusion Δb₂ to the small side walls S₃ and S₄;
4) bonding of the protrusion Δb₃ on the bottom side U to the small side walls S₃ and S₄;
5) bonding of the protrusion Δl₃ of the large side walls to the top side O of the battery cell;
6) bonding of the protrusion Δl₂ of the small side walls to the top side O of the battery cell.

In CM2, in comparison to M1-M5, the order of steps 3) and 4) and of steps 5) and 6) is reversed.

The results of the cladding of the battery cell according to Method Examples M1 -M5 and Comparative Method Examples CM1-CM2 are summarized in Table 3.

TABLE 3
Method Examples M1-M5 and Comparative
Method Examples CM1-CM2

| | M1 | M2 | M3 | M4 | M5 | CM1 | CM2 |
|---|---|---|---|---|---|---|---|
| Adhesive layer | K2 | K2 | K2 | K3 | K1 | K2 | K2 |

Infiltration test at 85° C./85% rh

| | | | | | | |
|---|---|---|---|---|---|---|
| + | + | + | + | + | − | − |

Pass: +
Fail: −

### Infiltration Test

In order to evaluate the bonding quality, a battery cell wrapped with insulating adhesive tape was stored for 1000 h in a conditioned chamber at 85° C. and 85% relative humidity (rh). The test was passed if after this time there was no edge lifting of any bond. Failure is if the insulating adhesive tape at at least one point (frequently in the region of the folds) detached and so stood at a distance from the cell.

Using bonding method M1, the adhesive films were also bonded with the adhesive layers K1 and V1 and evaluated. With K1, a sufficient bond strength of more than 4 MPa was achieved and the infiltration test was passed. Comparative Example V1 is a commercial pressure-sensitive adhesive, tesa® 58353, which lacks sufficient bond strength to serve as a bonding basis for further liquid adhesives. While Examples V2 and V3 are distinguished by high bond strengths after curing, they are too soft, owing to absence of solid epoxy resins and too low a polymer fraction, respectively, giving the adhesive layer too low a cohesion, this being manifested in the uncured state by cohesive failure in the peel adhesion test. Such soft adhesives are less suitable for the method claimed, since on the one hand, owing to their low cohesion, they tend to emerge from the side of the wound adhesive tape rolls, causing the rolls to stick, and on the other hand, on bonding around edges, the restoring force of the carrier film may lead to edge lifting or detachment of the film. In Comparative Method CM1, the folded connection at the small side walls S₃ and S₄, which was bonded in step 4), parted. In Comparative Method CM2, the edges of the small side walls of the top side, which was bonded in step 6), parted.

What is claimed:

1. A method for cladding a battery cell, the method comprising:
(i) providing a battery cell comprising at least two opposite side walls S₁ and S₂, at least two opposite side walls S₃ and S₄, at least one bottom side U, and at least one top side O;
(ii) providing an adhesive film comprising at least one crosslinkable adhesive layer and at least one carrier;
(iii) contacting the adhesive film of (ii) and the at least one bottom side U of the battery cell of (i), comprising adhesively bonding the at least one crosslinkable adhesive layer of the adhesive film and the at least one bottom side U of the battery cell;
(iv) contacting the adhesive film and the at least two side walls S₁ and S₂, comprising adhesively bonding the at least one crosslinkable adhesive layer of the adhesive film and the at least two side walls S₁ and S₂;
(v) contacting the adhesive film and the at least two side walls S₃ and S₄, comprising adhesively bonding the at least one crosslinkable adhesive layer of the adhesive film and the at least two side walls S₃ and S₄; and
(vi) contacting the adhesive film and the at least one top side O, comprising adhesively bonding the at least one crosslinkable adhesive layer of the adhesive film and the at least one top side O of the battery cell;
wherein the method further comprises at least partly crosslinking the crosslinkable adhesive layer, where the at least partly crosslinking may be carried out after (ii) to (vi).

2. The method of claim 1, wherein the carrier comprises an insulating carrier having a specific volume resistivity of >10¹⁵ Ωcm, determined according to DIN EN 62631-3-1 (VDE 0307-3-1): 2017-01.

3. The method of claim 1, wherein the carrier comprises one or more materials selected from the group consisting of polyimide, polybenzimidazole, polyamideimide, polyetherimide, polyacetal, polyphenylene sulfide, polyetheretherketone, polytetrafluoroethylene, polyamide 6, ultra-high molecular weight polyethylene, polypropylene, vinyl chloride resin, polystyrene, polyethylene terephthalate, acrylonitrile-butadiene-styrene, polycarbonate, polyvinyl chloride, ethylene-vinyl acetate, polyester, and a combination thereof.

4. The method of claim 1, wherein the crosslinkable adhesive layer has a thickness in the range from 10 to 150 μm.

5. The method of claim 1, wherein the crosslinkable adhesive layer comprises a crosslinkable pressure-sensitive adhesive that comprises at least one polymer, at least one epoxy resin, and at least one photoinitiator.

6. The method of claim 5, wherein the crosslinkable pressure-sensitive adhesive comprises
(a) 25% to 75%, by weight of at least one polymer;
(b) 20% to 70%, by weight of at least one epoxy resin;
(c) 0.01% to 5%, by weight of at least one cationic photoinitiator.

7. The method of claim 5, wherein the at least one epoxy resin comprises at least one epoxy resin E₁ and at least one epoxy resin E₂, and wherein the at least one epoxy resin E₁ has a Tg of ≥25° C. and the at least one epoxy resin E₂ has a Tg of <25° C., determined according to Test Method 3.

8. The method of claim 5, wherein the crosslinkable pressure-sensitive adhesive further comprises
(d) 3% to 30%, by weight, based on the sum of the % by weight of the at least one polymer and of the at least one epoxy resin, of at least one elastomer-modified epoxide E₃ that comprises one or more materials selected from the group consisting of carboxy-terminated nitrile rubber, carboxy-terminated butadiene rubber, epoxy-terminated butadiene rubber, epoxy-terminated nitrile rubber, epoxy-functionalized polyurethane, polyester, polyether, and a combination thereof.

9. The method of claim 1, wherein the at least partial crosslinking of the crosslinkable adhesive layer is carried out after (ii) or wherein the at least partial crosslinking of the crosslinkable adhesive layer is carried out after (vi).

10. The method of claim 1, wherein the adhesive film has a width b and a length l, wherein, in (iii), the width b of the adhesive film protrudes by area Δb₁ beyond the bottom side U of the battery cell, wherein, in (iv), the width b of the adhesive film protrudes by area Δb₂ beyond the at least two opposite side walls S₁ and S₂ of the battery cell and by area Δb₃ beyond the bottom side U of the battery cell, wherein Δb₃<Δb₂<Δb₁ and Δb₂<Δb₁ and where (v) comprises:
(v.1) applying Δb₂ to the at least two side walls S₃ and S₄, comprising adhesively bonding the adhesive layer of the adhesive film and the at least two side walls S₃ and S₄; and
(v.2) applying Δb₂ to the at least two side walls S₃ and S₄, comprising adhesively bonding the adhesive layer of the adhesive film and the at least two side walls S₃ and S₄, to form area Δl₂.

11. The method of claim 10, wherein (vi) comprises:
(vi.1) applying Δl₂ to the top side O of the battery cells, comprising adhesively bonding the adhesive layer of the adhesive film and the at least one top side O, to form area Δl₃, where Δl₃<Δl₂; and
(vi.2) applying Δl₃ to the top side O of the battery cell, comprising adhesively bonding the adhesive layer of the adhesive film and the at least one top side O.

12. A clad battery cell, obtainable or obtained by the method claim 1.

13. The method of claim 2, wherein the insulating carrier is an electrically insulating carrier having a specific volume resistivity of >10¹⁶ Ωcm, determined according to DIN EN 62631-3-1 (VDE 0307-3-1): 2017-01.

14. The method of claim 2, wherein the insulating carrier is an electrically insulating carrier having a specific volume resistivity of >10¹⁷ Ωcm, determined according to DIN EN 62631-3-1 (VDE 0307-3-1): 2017-01.

15. The method of claim 3, wherein the one or more materials are selected from the consisting of polypropylene, polyethylene terephthalate, polycarbonate and polyvinyl chloride.

16. The method of claim 4, wherein the thickness of the crosslinkable adhesive layer has the range from 10 to 100 μm.

17. The method of claim 4, wherein the thickness of the crosslinkable adhesive layer has the range from 20 to 60 μm.

18. The method of claim 1, wherein the crosslinkable pressure-sensitive adhesive comprises
(a) 30% to 70%, by weight of at least one polymer;
(b) 30% to 65%, by weight of at least one epoxy resin;
(c) 1% to 4%, by weight of at least one cationic photoinitiator.

19. The method of claim 1, wherein the crosslinkable pressure-sensitive adhesive further comprises
(d) 5% to 20%, by weight, based on the sum of the % by weight of the at least one polymer and of the at least one epoxy resin, of at least one elastomer-modified epoxide E₃ and wherein the at least one elastomer-modified epoxide E₃ comprises one or more materials selected from the group consisting of carboxy-terminated nitrile rubber, carboxy-terminated butadiene rubber, epoxy-terminated butadiene rubber, epoxy-terminated nitrile rubber, epoxy-functionalized polyurethane, polyester, polyether, and a combination thereof.

20. The method of claim 1, wherein the crosslinkable pressure-sensitive adhesive further comprises
(d) 7% to 15%, by weight, based on the sum of the % by weight of the at least one polymer and of the at least one epoxy resin, of at least one elastomer-modified epoxide E₃ and wherein the at least one elastomer-modified epoxide E₃ comprises one or more materials selected from the group consisting of carboxy-terminated nitrile rubber, carboxy-terminated butadiene rubber, epoxy-terminated butadiene rubber, epoxy-terminated nitrile rubber, epoxy-functionalized polyurethane, polyester, polyether, and a combination thereof.
